(19) United States
(12) Patent Application Publication
(10) Pub. No.: US 2026/0128052 A1
(43) Pub. Date: May 7, 2026

(54) APPARATUS AND METHOD FOR REMOVING AMBIENT NOISE IN SPEECH WAVEFORM BY USING BAND-PASS FILTER AND DEEP LEARNING

(71) Applicant: hearDL Ltd., Pohang-si, Gyeongsangbuk-do (KR)

(72) Inventor: Young Hoon PARK, Pohang-si, Gyeongsangbuk-do (KR)

(73) Assignee: hearDL Ltd., Pohang-si, Gyeongsangbuk-do (KR)

(21) Appl. No.: 19/122,205

(22) PCT Filed: Nov. 2, 2022
(86) PCT No.: PCT/KR2022/016958

§ 371 Date: Apr. 17, 2025

(30) Foreign Application Priority Data
Oct. 21, 2022 (KR) 10-2022-0136825

(51) Int. Cl. G10L 21/0224; G10L 21/0232; G10L 25/30; G10L 25/90

(52) U.S. Cl. CPC G10L 21/0224; G10L 21/0232; G10L 25/30; G10L 25/90

(57) ABSTRACT

The present invention relates to an apparatus and a method for removing ambient noise from a speech waveform by using a band-pass filter and deep learning, wherein the apparatus and method are implemented to remove ambient noise from a speech waveform combined with the ambient noise and extract only a clean speech waveform so that a human's speech can be easily understood.

### TECHNICAL FIELD

The present disclosure relates to an apparatus and method for removing ambient noise from a speech waveform, and more particularly, to an apparatus and method for removing ambient noise from a speech waveform by using a band-pass filter and deep learning, which have been embodied to enable a person's voice to be easily heard by removing ambient noise from a speech waveform combined with the ambient noise and extracting only a clean speech waveform.

### BACKGROUND ART

Research of speech de-noising that removes ambient noise from a speech waveform and that extracts only a clean speech waveform has been performed for a relatively long time. A speech de-noising algorithm that is now used a lot includes a Wiener filter, which is now widely used in smartphones, etc.

In general, a smartphone has two microphones embedded on upper and lower sides thereof, respectively. The lower-side microphone that is disposed close to a user's mouth receives a voice+a noise waveform, and the upper-side microphone that is disposed far away from the user's mouth generally receives a noise waveform. A relatively clean speech waveform on which the influence of noise has been reduced is obtained by applying the Wiener filter to the two waveforms.

Recently, a deep learning technology is actively applied to speech de-noising research, and is commonly divided into a time-frequency mask method and a method that is directly applied to a speech waveform.

The time-frequency mask method converts a speech waveform, that is, a one-dimensional matrix (vector) for [time] into a frequency spectrogram, that is, a two-dimensional matrix of [time, frequency], and makes 0 specific components related to noise, among the two-dimensional [time, frequency] components of the frequency spectrogram, or reduces the size thereof and then converts the specific component into a new speech waveform.

A process of converting a speech waveform into a frequency spectrogram is as follows.

First, a speech waveform is split into continued time intervals called frames, and short time Fourier transform (STFT) is performed on one frame time interval waveform. Accordingly, a speech waveform corresponding to one frame time interval is converted into a set of complex number frequency spectra. For example, when one frame time is 25 ms and a frame step time is 10 ms in a speech waveform having a sample rate of 48,000 per second, one frame includes 1,200 speech data, and the start times of two frames that temporally neighbor have a difference of a step time (10 ms). Accordingly, the two frames that temporally neighbor overlap every 15 ms (720 speech data).

An STFT output for the one frame time interval includes 1,200 complex numbers. One complex number indicates one frequency component. Only 601 complex numbers of the first half, among the 1,200 complex numbers, are used in a subsequent calculation process because the second half of the 1,200 complex numbers is a complex conjugate of the first half thereof. The first of the first half 601 complex numbers is a DC component (0 Hz), the second thereof is a 40 Hz component (a value obtained by dividing the sample rate 48,000 Hz by the number 1,200 of data of one frame), the third thereof is an 80 Hz component, the fourth is a 120 Hz component to a 601-th thereof is a 24,000 Hz component. Accordingly, a speech waveform is converted into a frequency spectrogram including 601 complex numbers every 10 ms of the step time. That is, a frequency spectrogram is a two-dimensional matrix of [t, f]. In the above example, the t dimension index 1 corresponds to 10 ms, and the f dimension index 1 corresponds to 40 Hz.

The time-frequency mask method generates a new frequency spectrogram by either setting to zero or reducing the magnitude of components, determined to be related to noise, among the two-dimensional matrix components of the frequency spectrogram, and generates and outputs a new speech waveform by performing an inverse STFT operation on the newly generated frequency spectrogram.

When listening to an output speech waveform obtained by applying the time-frequency mask method to a speech waveform combined with noise, an unnatural portion of speech is occasionally found. In order to obtain a more natural speech output, a method of directly applying deep learning to a speech waveform without converting the speech waveform into a frequency spectrum is used.

Such a method enables a real-time operation in a notebook computer because a computational load for deep learning is relatively small, and can reduce time non-stationary noise in addition to time stationary noise.

However, such a conventional method receives one speech waveform including a predetermined number of speech data that temporally neighbor as an input, and outputs only another speech waveform including the same number of speech data. Accordingly, the method has a problem in that ambient noise cannot be uniformly removed in all of audible frequency bands from a speech waveform combined with ambient noise in an environment in which ambient noise is severe.

### DISCLOSURE

### Technical Problem

Objects of the present disclosure are to provide an apparatus for removing ambient noise from a speech waveform using band-pass filters and deep learning and a method of removing ambient noise using the same, which can extract only a speech waveform which can be clearly heard by a person by uniformly removing ambient noise in all of audible frequency bands from a speech waveform combined with ambient noise in order to clearly hear only a person's voice in an environment in which ambient noise is severe.

### Technical Solution

In order to achieve the object, an apparatus for removing ambient noise from a speech waveform using band-pass filters and deep learning according to the present disclosure includes an ambient noise removal unit configured to receive a first speech waveform as an input, remove noise through filtering and deep learning, and then output a fourth speech waveform and a deep learning training unit configured to calculate deep learning weights that are used in deep learning through the deep learning training and to provide the deep learning weights to the ambient noise removal unit.

The ambient noise removal unit includes a filter unit configured to output a plurality of second waveforms by receiving the one first speech waveform as an input, a deep learning unit configured to output a plurality of third waveforms by receiving the plurality of second waveforms as an input, and a summing unit configured to output the one fourth speech waveform by summing up the plurality of third waveforms.

The filter unit includes a plurality of delayed filters configured to receive the one first speech waveform as an input and to output the plurality of second waveforms by delaying the one first speech waveform.

The plurality of delayed filters each have a structure in each of a plurality of band-pass filters and each of a plurality of delay units are connected in series.

The deep learning unit includes an encoder unit configured to output a plurality of seventh waveforms and a plurality of sixth waveforms by receiving the plurality of second waveforms as an input, a unidirectional LSTM unit configured to output a plurality of eighth waveforms by receiving the plurality of sixth waveforms as an input, and a decoder unit configured to outputs the plurality of third waveforms by receiving the plurality of seventh waveforms and the plurality of eighth waveforms as an input.

It is preferred that the encoder unit has a structure in which a plurality of CNN encoders is connected in series.

It is preferred that the decoder unit has a structure in which a plurality of detail decoders each outputting one waveform that constitutes the third waveform by receiving the seventh waveform and the eighth waveform as an input is connected in parallel.

The decoder unit may further include one detail decoder configured to selectively output one fifth waveform by receiving the seventh waveform and the eighth waveform as an input.

Each of the plurality of detail decoders includes a first number change deep learning device configured to receive the eighth waveform as an input and a plurality of decoder stages connected to the first number change deep learning device in series.

The deep learning training unit includes a second summing unit configured to receive a clean ground truth speech waveform and an ambient noise waveform as an input and to generate the first speech waveform by summing up the clean ground truth speech waveform and the ambient noise waveform, a second filter unit configured to output a plurality of thirteenth waveforms by receiving the clean ground truth speech waveform as an input, and a deep learning training engine configured to calculate the deep learning weights by receiving the plurality of thirteenth waveforms and the plurality of third waveforms generated by the ambient noise removal unit as an input and to provide the deep learning weights to the ambient noise removal unit.

The deep learning training unit may further include a pitch sine wave generator configured to output a plurality of fifteenth waveforms by receiving the clean ground truth speech waveform as an input and to provide the plurality of fifteenth waveforms to the deep learning training engine.

The deep learning training engine includes a plurality of relative error calculation units configured to calculate average relative error values of the plurality of third waveforms for the plurality of thirteenth waveforms, a relative error summing unit configured to calculate an average relative error sum value by summing up the average relative error values output by the plurality of relative error calculation units, and a deep learning weight calculation unit configured to calculate the deep learning weights so that the average relative error sum value is reduced.

It is preferred that the deep learning training engine further includes one relative error calculation unit configured to calculate average relative error values of the plurality of fifth waveforms for the plurality of fifteenth waveforms.

In order to achieve the another object, a method of removing ambient noise from a speech waveform using band-pass filters and deep learning according to the present disclosure includes generating a plurality of deep learning output waveforms by using a plurality of narrow band waveforms, which is generated by passing an input speech waveform through a plurality of band-pass filters, as an input for deep learning, and then generating an output speech waveform having ambient noise greatly reduced by summing up the plurality of output waveforms. The deep learning additionally outputs one waveform in addition to the deep learning output waveforms. The deep learning is trained so that the added waveform outputs pitch information of a clean speech waveform from which ambient noise has been removed in a speech waveform combined with the ambient noise. Pitch information of one speech waveform learnt by the deep learning is used to generate the plurality of deep learning output waveforms.

The pitch sine wave generator may generate a twenty-first speech waveform obtained by delaying the clean ground truth speech waveform by latency of first speech waveform of the second waveform, may extract all of pitch start times of the twenty-first speech waveform during a voiced speech time interval of the twenty-first speech waveform, and may generate one fifteenth waveform having a sine wave, having a period identical with a pitch period of the twenty-first speech waveform, and having a maximum value at the pitch start time of the twenty-first speech waveform.

The deep learning training engine adds an average relative error value of the fifth waveform for the fifteenth waveform to the average relative error sum value in a deep learning training process and then determines a deep learning weight value so that the added average relative error sum value is reduced. The deep learning unit uses the pitch information of the clean ground truth speech waveform when learning the pitch information of the clean ground truth speech waveform and outputting the plurality of third waveforms.

### Advantageous Effects

According to the apparatus and method for removing ambient noise from a speech waveform by using a band-pass filter and deep learning according to the present disclosure, there is an advantage in that a person's voice can be easily heard by uniformly removing ambient noise in all of audible frequency bands from a speech waveform combined with ambient noise and extracting only a clean speech waveform.

The reason is as follows. In deep learning according to the present disclosure, the plurality of second waveforms generated by passing the input first speech waveform through the plurality of band-pass filters is used as an input for deep learning, and the plurality of third waveforms is output. The deep learning is trained so that the plurality of third waveforms becomes identical with the plurality of thirteenth waveforms generated by passing a clean ground truth speech waveform through the plurality of band-pass filters. The plurality of third waveforms is summed up and output as the fourth speech waveform. Accordingly, the fourth speech waveform becomes a relatively clean waveform in which ambient noise has been greatly reduced uniformly in a frequency range in which the band-pass frequencies of the plurality of band-pass filters has been combined.

### DESCRIPTION OF DRAWINGS

The patent or application file contains at least one drawing executed in color. Copies of this patent or patent application publication with color drawings will be provided by the Office upon request and payment of the necessary fee.

FIG. 1 is a diagram illustrating some components of an apparatus for removing ambient noise from a speech waveform using band-pass filters and deep learning according to the present disclosure.

FIG. 2 is a diagram illustrating all of the components of the apparatus for removing ambient noise from a speech waveform using band-pass filters and deep learning according to the present disclosure.

FIG. 3 is a diagram illustrating a person's hearing threshold for a frequency.

FIG. 4 is a diagram illustrating detailed components of a filter unit of the apparatus for removing ambient noise from a speech waveform using band-pass filters and deep learning according to the present disclosure.

FIG. 5 is a diagram illustrating a magnitude characteristic of a sum transfer function in which the complex number transfer functions of seven band-pass filters are summed up in the apparatus for removing ambient noise from a speech waveform using band-pass filters and deep learning according to the present disclosure.

FIG. 6 is a diagram illustrating a phase characteristic of the sum transfer function in which the complex number transfer functions of the seven band-pass filters of the apparatus for removing ambient noise from a speech waveform using band-pass filters and deep learning according to the present disclosure are summed up.

FIG. 7 is a diagram illustrating a group delay characteristic of the sum transfer function in which the complex number transfer functions of the seven band-pass filters of the apparatus for removing ambient noise from a speech waveform using band-pass filters and deep learning according to the present disclosure are summed up.

FIG. 8 is a diagram illustrating detailed components of a deep learning unit of the apparatus for removing ambient noise from a speech waveform using band-pass filters and deep learning according to the present disclosure.

FIG. 9 is a diagram illustrating detailed components of an encoder unit of the deep learning unit illustrated in FIG. 8.

FIG. 10 is a diagram illustrating detailed components of a decoder unit of the deep learning unit illustrated in FIG. 8.

FIG. 11 is a diagram illustrating detailed components of a detail decoder of the decoder unit illustrated in FIG. 10.

FIG. 12 is a diagram illustrating detailed components of a fourth decoder stage of the detail decoder illustrated in FIG. 11.

FIG. 13 is a diagram illustrating detailed components of a deep learning training engine of the apparatus for removing ambient noise from a speech waveform using band-pass filters and deep learning according to the present disclosure.

FIG. 14 is a diagram illustrating all of waveforms according to the execution of the deep learning unit of the apparatus for removing ambient noise from a speech waveform using band-pass filters and deep learning according to the present disclosure.

FIG. 15 is an enlarged diagram of some intervals of all of the waveforms of FIG. 14.

FIG. 16 is a diagram illustrating pitch waveforms according to the execution of the deep learning unit of the apparatus for removing ambient noise from a speech waveform using band-pass filters and deep learning according to the present disclosure.

FIG. 17 is a diagram illustrating output waveforms of a first band-pass filter according to the execution of the deep learning unit of the apparatus for removing ambient noise from a speech waveform using band-pass filters and deep learning according to the present disclosure.

FIG. 18 is a diagram illustrating output waveforms of a second band-pass filter according to the execution of the deep learning unit of the apparatus for removing ambient noise from a speech waveform using band-pass filters and deep learning according to the present disclosure.

FIG. 19 is a diagram illustrating output waveforms of a third band-pass filter according to the execution of the deep learning unit of the apparatus for removing ambient noise from a speech waveform using band-pass filters and deep learning according to the present disclosure.

FIG. 20 is a diagram illustrating output waveforms of a fourth band-pass filter according to the execution of the deep learning unit of the apparatus for removing ambient noise from a speech waveform using band-pass filters and deep learning according to the present disclosure.

FIG. 21 is a diagram illustrating output waveforms of a fifth band-pass filter according to the execution of the deep learning unit of the apparatus for removing ambient noise from a speech waveform using band-pass filters and deep learning according to the present disclosure.

FIG. 22 is a diagram illustrating output waveforms of a sixth band-pass filter according to the execution of the deep learning unit of the apparatus for removing ambient noise from a speech waveform using band-pass filters and deep learning according to the present disclosure.

FIG. 23 is a diagram illustrating output waveforms of a seventh band-pass filter according to the execution of the deep learning unit of the apparatus for removing ambient noise from a speech waveform using band-pass filters and deep learning according to the present disclosure.

### MODE FOR INVENTION

In the present disclosure, the following two constructions are used.

The characteristic of the first construction of the present disclosure is to generate L deep learning output waveforms by using, as an input for deep learning, L narrow frequency band waveforms generated by passing an input speech waveform through L band-pass filters having different band-pass frequencies, instead of directly using the input speech waveform as the input for the deep learning, and then to generate an output speech waveform having ambient noise greatly reduced by summing up the L output waveforms.

The characteristic of the second construction of the present disclosure is to use pitch information of a clean speech that has been learnt when the L deep learning output waveforms are generated by learning the pitch information of the clean speech through the deep learning based on the property that the pitch of a speech is robust against ambient noise due to its great amplitude. To this end, the deep learning additionally outputs one waveform in addition to the L deep learning output waveforms. The deep learning is trained so that the added waveform outputs pitch information of a clean speech waveform from which ambient noise has been removed in a speech waveform combined with the ambient noise. Pitch information of a speech waveform learnt by the deep learning is used to generate the L deep learning output waveforms.

A more detailed method of embodying the characteristics of the two constructions is as follows.

In a deep learning training process, a first speech waveform is generated by receiving two waveforms of a clean ground truth speech waveform not having ambient noise and an ambient noise waveform as an input and summing up the clean ground truth speech waveform and the ambient noise waveform. L second waveforms are generated by passing the first speech waveform through a filter unit 100 including L band-pass filters having different band-pass frequencies.

L third waveforms and one fifth waveform are generated as the output of a deep learning unit 200 by applying the second waveform to the deep learning unit 200 as an input. L thirteenth waveforms are generated by passing the clean ground truth speech waveform through a second filter unit 600 that performs exactly the same operation as the filter unit 100. A fifteenth waveform is generated by passing the clean ground truth speech waveform through a pitch sine wave generator 700.

In this case, the fifteenth waveform is a sine wave form having a maximum value at a pitch start time during a voiced speech time interval of the clean ground truth speech waveform, having a period identical with a pitch period, and having amplitude that varies based on a peak value of the clean ground truth speech waveform.

Thereafter, one waveform combination including two waveforms is produced by selecting one waveform from the L third waveforms and selecting one waveform from the L thirteenth waveforms. L waveform combinations are produced so that the waveforms do not overlap. An average relative error value of a waveform selected, among the third waveforms, for a waveform selected, among the thirteenth waveforms, with respect to each of the L waveform combinations is calculated. One average relative error sum value is calculated by summing up the average relative error value of each of the L combinations and the average relative error value of the fifth waveform with respect to the fifteenth waveform. The weight values of the deep learning unit 200 are adjusted so that the average relative error sum value is reduced in the deep learning training process.

Meanwhile, center frequencies of the pass frequency bands of the L band-pass filters that constitute L delayed filters have different values having a log-linear relation. The transfer function of each band-pass filter is the product of four or more second-order band-pass filter transfer functions. When an absolute value of a complex number sum transfer function value obtained by summing up all of the frequency region complex number transfer function values of the L band-pass filters is calculated, a value obtained by dividing a maximum value of the absolute value by a minimum value of the absolute value with respect to a frequency range from 90 Hertz (Hz) to 11,000 Hz is smaller than 3 decibel (dB) (1.414). The L delay units that constitute the L delayed filters enable pieces of latency of L waveforms that constitute a second waveform with respect to the first speech waveform to be generally identical with each other and to be each generally identical with a maximum value, among group delay values of the L band-pass filters, so that pieces of latency of the L delayed filters are generally identical with each other and each have a minimum value by compensating for a difference between the group delays of the L band-pass filters.

Accordingly, there can be obtained an effect in that ambient noise is greatly reduced in all of frequency ranges corresponding to the band-pass frequencies of the L band-pass filters in a fourth speech waveform in which the L output waveforms of the deep learning unit 200 have been summed up.

Hereinafter, the present disclosure is described in detail with reference to the drawings.

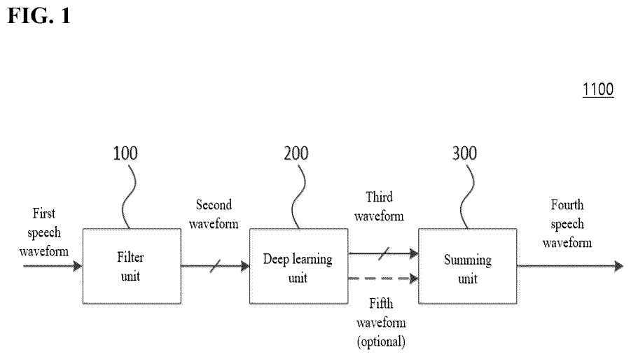

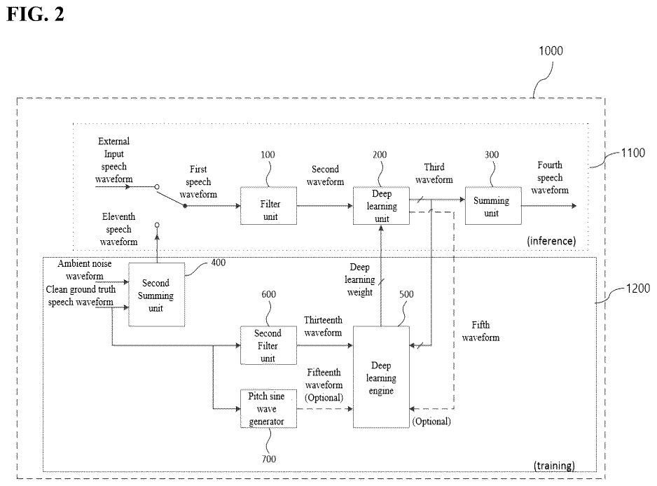

FIG. 1 is a diagram illustrating some components of an apparatus for removing ambient noise from a speech waveform using band-pass filters and deep learning according to the present disclosure. FIG. 2 is a diagram illustrating all of the components of the apparatus for removing ambient noise from a speech waveform using band-pass filters and deep learning according to the present disclosure.

As illustrated in FIGS. 1 and 2, the apparatus 1000 for removing ambient noise from a speech waveform using band-pass filters and deep learning according to the present disclosure includes an ambient noise removal unit 1100 and a deep learning training unit 1200.

The ambient noise removal unit 1100 includes the filter unit 100, the deep learning unit 200, and the summing unit 300.

The filter unit 100 includes the L band-pass filters having different band-pass frequencies, receives the first speech waveform as an input, and outputs the plurality of L second waveforms.

The deep learning unit 200 receives the L second waveforms and outputs the L third waveforms. The deep learning unit 200 has been trained to minimize the sum of average relative errors of the L third waveforms for the L thirteenth waveforms generated by passing a clean ground truth speech waveform from which ambient noise has been removed from the first speech waveform through the second filter unit 600 that performs exactly the same operation as the filter unit 100 in a deep learning training process.

More specifically, one waveform combination including two waveforms is produced by selecting one waveform, among the third waveforms, and selecting one waveform, among the thirteenth waveforms, with respect to the L third waveforms and the L thirteenth waveforms. L waveform combinations are produced so that the waveforms do not overlap. Average relative error values of the two waveforms that constitute each combination are calculated with respect to each of the L waveform combinations. One average relative error sum value is calculated by summing up all of the average relative error values of the L combinations. Thereafter, the weight values of the deep learning unit 200 are adjusted so that the average relative error sum value is reduced in a deep learning training process.

Accordingly, the L third waveforms, that is, the output of the deep learning unit 200, becomes almost the same as the L thirteenth waveforms, respectively, which are output by passing the clean ground truth speech waveform through the L band-pass filters. Accordingly, the fourth speech waveform has ambient noise greatly reduced uniformly in a frequency range in which all of the band-pass frequencies of the L band-pass filters are summed up.

The deep learning unit 200 may additionally output one fifth waveform. The fifth waveform is not used to generate the fourth speech waveform, and the deep learning unit 200 has been trained so that the fifth waveform becomes identical with the fifteenth waveform that is generated from the clean ground truth speech waveform.

More specifically, the deep learning unit 200 is trained to calculate a final sum value by adding an average relative error value of the fifth waveform for the fifteenth waveform to the average relative error sum value and to reduce the final sum value.

The fifteenth waveform has a sine wave form including pitch information of the clean ground truth speech waveform during a voiced speech time interval of the clean ground truth speech waveform, and is 0 during an unvoiced speech time interval.

The fifteenth waveform has a sine wave having a maximum value every pitch start time of the clean ground truth speech waveform during the voiced speech time interval of the clean ground truth speech waveform, having a period identical with a pitch period, and having amplitude having a value similar to an instant peak value (envelope) of the clean ground truth speech waveform.

Accordingly, the deep learning unit 200 learns the pitch information of the clean ground truth speech waveform, and thus uses the pitch information of the clean ground truth waveform in outputting the L third waveforms.

The summing unit 300 outputs the fourth speech waveform by summing up the L third waveforms.

The deep learning training unit 1200 includes a second summing unit 400, a deep learning training engine 500, the second filter unit 600, and the pitch sine wave generator 700.

When inferring to the ambient noise removal unit 1100, an external input speech waveform including ambient noise is received as the first speech waveform, and the fourth speech waveform having the ambient noise greatly reduced is output through the filter unit 100, the pre-trained deep learning unit 200, and the summing unit 300. The deep learning training unit 1200 trains the deep learning unit 200 that constitutes the ambient noise removal unit 1100.

The second summing unit 400 receives the two waveforms of the clean ground truth speech waveform and the ambient noise waveform as an input, and generates an eleventh speech waveform by summing up the two waveforms. The filter unit 100 receives the eleventh speech waveform as the first speech waveform and outputs the L third waveforms through the deep learning unit 200. The L third waveforms are subdivided into a (3_1)-th waveform, a (3_2)-th waveform, a (3_3)-th waveform to a (3_L)-th waveform for future description. The deep learning unit 200 may additionally output the fifth waveform.

The L thirteenth waveforms are generated by passing the clean ground truth speech waveform through the second filter unit 600 that performs exactly the same operation as the filter unit 100. The fifteenth waveform is generated by passing the clean ground truth speech waveform through the pitch sine wave generator 700. The L thirteenth waveforms are subdivided into a (13_1)-th waveform, a (13_2)-th waveform, a (13_3)-th waveform to a (13_L)-th waveform for future description.

The deep learning training engine 500 calculates an average relative error sum value of the third waveform for the thirteenth waveform, and adjusts a deep learning weight value of the deep learning unit 200 so that the sum value becomes small. In order to calculate the average relative error sum value of the third waveform for the thirteenth waveform, first, L waveform combinations each including two waveforms are produced as follows so that the two waveforms do not overlap by selecting one waveform, among the third waveforms, and selecting another waveform, among the thirteenth waveforms. A combination1 includes {(3_1)-th waveform, (13_1)-th waveform}. A combination2 includes {(3_2)-th waveform, (13_2)-th waveform}. A combination3 includes {(3_3)-th waveform, (13_3)-th waveform}. A combination includes {(3_L)-th waveform, (13_L)-th waveform}.

An average relative error value of the third waveform for the thirteenth waveform of each combination is calculated and an average relative error sum value is calculated by summing up the L average relative error values according to Equation 1.

$$Average relative error = sum ( i = 1 , 2 , 3 , … , N ) \{ \vert noisy [ i ] - clean [ i ] \vert / ( mean \{ \vert clean [ i ] \vert \} + 1 e - 3 ) \} / N \qquad [ Equation 1 ]$$

Equation 1 is an equation that calculates a relative error of a waveform (noisy) including noise of a clean waveform (clean). When calculating an average relative error value of the (3_1)-th waveform including a clean (13_1)-th waveform in the combination1, noisy[i] and clean[i] are i-th sample values of the (3_1)-th waveform and the (13_1)-th waveform, respectively. N is the number of samples of each waveform. mean{|clean[i] |} is an averaged value of absolute values of each sample value of the (13_1)-th waveform.

The average relative error value of the fifth waveform for the fifteenth waveform may be selectively added to the average relative error sum value. If deep learning training is performed by adding the average relative error value of the fifth waveform for the fifteenth waveform to the average relative error sum value, the fifth waveform becomes almost identical with the fifteenth waveform by an operation of the deep learning unit 200 because the speech waveform of the clean ground truth speech waveform is stored in the sine wave form during the voiced speech time interval of the pitch information of the clean ground truth. Accordingly, the deep learning unit 200 may use the pitch information of the clean ground truth speech waveform to generate the third waveform by learning the pitch information of the clean ground truth speech waveform.

The fifteenth waveform has a sine wave form during the voiced speech time interval of the clean ground truth speech waveform, and is 0 during the unvoiced speech time interval thereof. A speech waveform having a similar pattern is iterated every pitch period during the voiced speech time interval thereof. The iterated pattern has a waveform having a sine wave form, which has a frequency identical with a formant frequency starting from a waveform having a pulse form at a pitch start time and has amplitude reduced over time.

Furthermore, the pitch period is changed over time. The fifteenth waveform having the sine wave form is calculated by multiplying a cosine function and the envelope waveform of the clean ground truth speech waveform. The cosine function has a period identical with the pitch period of the clean ground truth speech waveform, has a maximum value at the pitch start time of the clean ground truth speech waveform, and has amplitude of 1.

The envelope waveform is a waveform that generally tracks the maximum value of the clean ground truth speech waveform. An envelope waveform value Envelope [i] in an I-th sample time is given as Equation 2.

$$Envelope [ i ] = MAX \{ \vert clean [ i ] \vert , Envelope [ i - 1 ] * exp ( - 1 / SR / TIME\_CONSTANT ) \} \qquad [ Equation 2 ]$$

In this case, |clean[i] | is an absolute value of the clean ground truth speech waveform in the I-th sample time. MAX(A, B) indicates a variable having a greater value among the variables A and B. In an embodiment of the present disclosure, a sample rate SR is 48,000/sec, and TIME_CONSTANT is 20 ms.

In general, a speech waveform is indicated as the sum of a low frequency waveform having greater amplitude and a high frequency waveform having small amplitude. If the speech waveform itself is used as an input for deep learning, deep learning weight values are determined so that a difference value between a deep learning output waveform and a ground truth speech waveform is minimized in an optimization learning process for the deep learning.

More specifically, an absolute value error waveform is generated by converting an error value at each sample time into an absolute value in one error waveform (error waveform) obtained by subtracting the ground truth speech waveform from the deep learning output waveform. In general, the deep learning weight value is determined so that an average value (L1 norm) for the time of the absolute value error waveform or an average value (L2 norm) for the time of a squared value of the absolute value error waveform is reduced.

Accordingly, the deep learning is trained so that one value (the L1 norm or the L2 norm) for the entire input speech waveform is reduced. In a low frequency region in which amplitude is relatively great, the deep learning output waveform and the input speech waveform are well matched. However, in a high frequency region in which amplitude is relatively small, the deep learning output waveform and the input speech waveform are not well matched. Accordingly, in general, in deep learning using a speech waveform as an input, low frequency noise is well removed, but high frequency noise is rarely removed.

A person's ear is good at hearing a sound having high intensity, that is, a sound having high sound pressure in a low frequency region, but is good at hearing a sound having low intensity in a high frequency region. That is, minimum sound pressure at which a sound can be heard by a person's ear is different depending on the frequency. A hearing threshold (HT), that is, a minimum sound pressure intensity at which a frequency f indicated in a Hertz (Hz) unit can be heard by a person's ear, is indicated in a decibel sound pressure level (dBSPL) unit as in Equation 3.

$$HT = 3.64 * ( f / 1000 ) \hat{} ( - 0.8 ) - 6.5 * exp \{ - 0 \text{.6} * ( f / 1000 - 3.3 ) \hat{} 2 \} + 0.001 * ( f / 1000 ) \hat{} 4 \qquad [ Equation 3 ]$$

In this case, “A” indicates an exponent, and “x \hat{ }2” is the square of x.

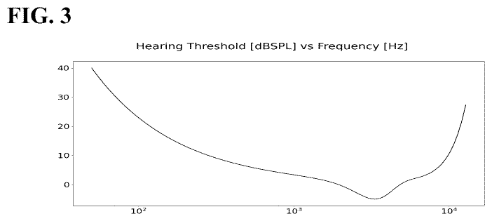

FIG. 3 is a diagram illustrating a person's hearing threshold for a frequency, and illustrates a person's hearing threshold for the frequency f.

dBSPL, that is, a hearing threshold unit, is a sound pressure unit. 0 dBSPL is sound pressure at which a 1000 Hz frequency can be barely heard by a person. Sound pressure of 1 Pascal corresponds to 98 dBSPL.

A sound having intensity having sound pressure that is about 178 times lower than sound pressure in a 3300 Hz frequency than in a 50 Hz frequency can be heard because a hearing threshold (HT) value is about 40 dBSPL in the 50 Hz frequency and is about-5 dB in the 3300 Hz frequency.

Accordingly, in deep learning that directly uses a speech waveform as an input, high frequency noise is well removed and a high frequency component is well heard by a person's ear although intensity thereof is low. Accordingly, in general, it is inconvenient to use the output waveform of the deep learning that directly uses a speech waveform as an input because high frequency noise is heard.

In the present disclosure, instead of directly applying deep learning to an input speech waveform, deep learning is applied to L narrow frequency band waveforms generated by passing the input speech waveform through the L band-pass filters having different band-pass frequencies. In an embodiment of the present disclosure, L=7 is set, and the band-pass frequency of each band-pass filter is a double frequency, that is, one octave.

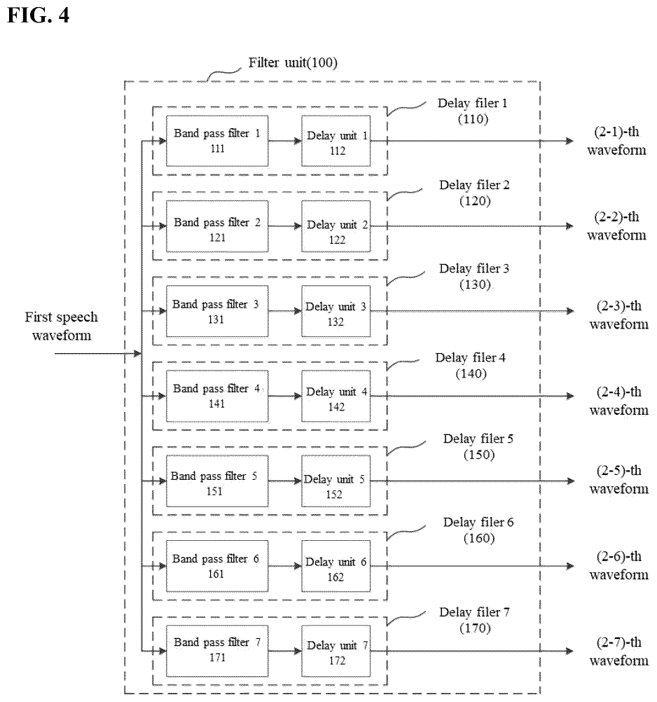

FIG. 4 is a diagram illustrating detailed components of the filter unit of the apparatus for removing ambient noise from a speech waveform using band-pass filters and deep learning according to the present disclosure.

As illustrated in FIG. 4, the filter unit 100 includes seven delayed filters 110 to 170. The delayed filters receive one first speech waveform as an input and output respective waveforms (a (2_1)-th waveform, a (2_2)-th waveform to a (2_7)-th waveform) that constitute a second waveform. For example, the delayed filter 110 has a structure in which a band-pass filter 111 and a delay unit 112 are connected in series.

The role of the delay unit is to add a latency having a different value to each band-pass filter so that a value obtained by summing up the latency of the band-pass filter and the latency of the delay unit is the same and minimized in each delayed filter, in order to compensate for a difference between the latency of each band-pass filter and a group delay value because the latency of each band-pass filter and the group delay value are different from each other.

In the filter unit 100 of FIG. 4, seven band-pass filters that constitute the seven delayed filters are called a band-pass filter1 111, a band-pass filter2 121 to a band-pass filter7 171 from the order of lower band-pass frequencies, for convenience sake.

In an embodiment of the present disclosure, if the band-pass frequencies of the seven band-pass filters are indicated as {the lowest frequency to the highest frequency} in the Hz unit, the band-pass filter1 has {88.4 to 176.8}, the band-pass filter2 has {176.8 to 353.5}, the band-pass filter3 has {353.5 to 707.1}, the band-pass filter4 has {707.1 to 1414.2}, the band-pass filter5 has {1414.2 to 2828.4}, the band-pass filter6 has {2828.4 to 5656.9}, and the band-pass filter7 has {5656.9 to 11313.7}. Accordingly, the band-pass frequencies do not overlap.

The center frequencies of the seven band-pass filters are each the same as a square root of a result value obtained by multiplying the lowest frequency value and highest frequency value of each band-pass frequency, and are 125 Hz, 250 Hz, 500 Hz, 1,000 Hz, 2,000 Hz, 4,000 Hz, and 8,000 Hz, respectively, which have a log-linear relation.

In an embodiment of the present disclosure, in order to minimize interference between the filters, each band-pass filter is based on a type-1 Chebyshev filter. The transfer function of the type-1 Chebyshev filter has a small ripple in the magnitude characteristic in the band-pass frequency, but has a characteristic in which the magnitude characteristic is rapidly monotonic-decreased as the frequency becomes distant from the center frequency of the band-pass filter in a stop band frequency. Accordingly, the transfer function minimizes interference between filters having neighboring band-pass frequencies.

Meanwhile, as the filter order is increased, interference between filters having neighboring band-pass frequencies is reduced. In an embodiment of the present disclosure, each band-pass filter has been embodied as an 8-order band-pass filter based on a type-1 Chebyshev low pass filter having a filter order of a fourth order.

It is preferred that the magnitude of the band-pass filter sum transfer function having an absolute value of a complex number sum value obtained by summing up all of the complex number transfer functions of the seven band-pass filters has a constant value in an audible frequency range.

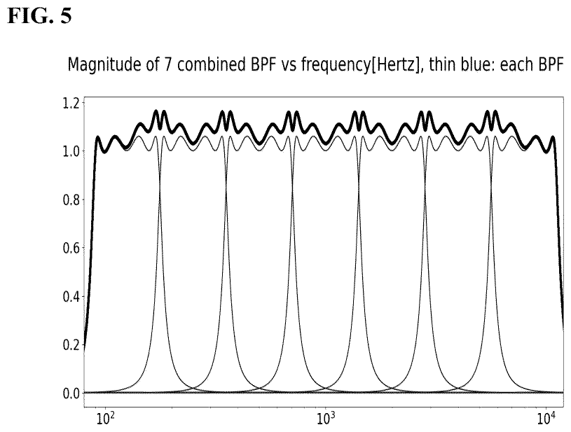

In an embodiment of the present disclosure, with respect to a frequency range from 90 Hz to 11,000 Hz, a value obtained by dividing a maximum value of the magnitude of the band-pass filter sum transfer function by a minimum value is about 1.18, which is smaller than a 3 dB value (about 1.414). Accordingly, as illustrated in FIG. 5, the magnitude characteristic of the band-pass filter sum transfer function is relatively uniform with respect to the frequency range.

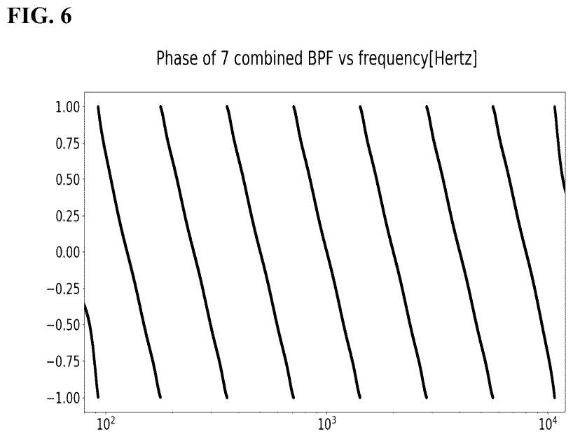

FIG. 6 is a diagram illustrating the phase characteristic of the sum transfer function in which the complex number transfer functions of the seven band-pass filters of the apparatus for removing ambient noise from a speech waveform using band-pass filters and deep learning according to the present disclosure are summed up. FIG. 6 illustrates values obtained by dividing the phase (radian unit) of the band-pass filter sum transfer function by a circular constant pi (pi=3.14159265 . . . ) with respect to frequencies.

The phase of the band-pass filter sum transfer function is decreased by 2*pi radian in each of all of the band-pass frequency intervals of the seven band-pass filters. The phase of the filter indicates the delay characteristic of a filter output signal for a filter input signal. An effective latency of the filter output signal for the filter input signal is called a group delay. The group delay is calculated by differentiating the phase of the filter transfer function by an angular frequency (angular frequency w=2*pi*f, f in Hertz) and then multiplying the result value by −1 as illustrated in Equation 4.

$$Group delay = - d \{ Phase of transfer function \} / dw \qquad [ Equation 4 ]$$

In FIG. 6, the band-pass frequency interval value (end frequency-start frequency) of the seven band-pass filters is doubled as the band-pass filter number is increased (from the band-pass filter1 to the band-pass filter7). A phase change in the band-pass frequency interval of each band-pass filter is the same as −2*pi radian.

Accordingly, according to Equation 4, in general, the group delay of each band-pass filter is given as an inverse number of a value that indicates the band-pass frequency of a corresponding band-pass filter in Hz. If this method is applied, general group delay values of the seven band-pass filters are given as 11.32 ms, 5.66 ms, 2.83 ms, 1.41 ms, 0.71 ms, 0.35 ms, and 0.18 ms, respectively, from the band-pass filter1 to the band-pass filter7. 1 ms is 1/1000 seconds. If one output speech waveform is generated by summing up seven output waveforms generated by passing one input speech waveform through the seven band-pass filters without any change, the output speech waveform has a waveform distortion phenomenon because the shape of the output speech waveform becomes different from that of the input speech waveform. The reason for this is that since the group delay values of L band-pass filters are different, a low frequency component of the input speech waveform has an output speech waveform that is relatively late because the latency of the input speech waveform attributable to the group delay of the band-pass filter is long and a high frequency component of the input speech waveform has an output speech waveform that is relatively quick because the latency of the input speech waveform attributable to the group delay of the band-pass filter is short.

In order to prevent the waveform distortion of the output speech waveform, all of the frequency components of the input speech waveform need to appear in the output speech waveform at the same time. To this end, as illustrated in FIG. 4, seven delay units having latencies of different values are added after the seven band-pass filters in order to identically adjust all of pieces of latency of the first speech waveform to the seven second waveforms (the (2_1)-th waveform, the (2_2)-th waveform to the (2_7)-th waveform) to the group delay value of the band-pass filter1 having the greatest group delay value, among the seven band-pass filters.

Accordingly, the latency of the delay unit1 is 0, and the latency of the delay unit2 is a value obtained by subtracting the group delay value of the band-pass filter2 from the group delay value of the band-pass filter1. Likewise, the latency of the delay unit7 is a value obtained by subtracting the group delay value of the band-pass filter7 from the group delay value of the band-pass filter1. Accordingly, the seven second waveforms are time-synchronized.

However, the group delay value calculated according to Equation 4 is slightly different from the general group delay value that is calculated assuming that the phase of the band-pass filter sum transfer function illustrated in FIG. 6 has a linear relation with respect to the frequency because the phase has a slight non-linear characteristic with respect to the frequency.

FIG. 7 is a diagram illustrating the group delay characteristic of the sum transfer function in which the complex number transfer functions of the seven band-pass filters of the apparatus for removing ambient noise from a speech waveform using band-pass filters and deep learning according to the present disclosure are summed up.

A thin dark line in FIG. 7 indicates a group delay value that is calculated by directly applying Equation 4 to the phase of the band-pass filter sum transfer function illustrated in FIG. 6. Furthermore, a thick blue line in FIG. 7 indicates an average group delay value of the band-pass frequencies of the seven band-pass filters.

In an embodiment of the present disclosure, all of analog speech waveforms are sampled, converted into digital codes, and converted into digital speech waveforms, and then experience a signal processing process in the filter unit 100, the deep learning unit 200, etc. Accordingly, it is convenient to perform the time delay in a sample period unit. If the sample rate is 48,000 per second, a time delay of 1 ms becomes the delay of a 48 sample period.

If the average group delay values of the band-pass frequencies of the seven band-pass filters illustrated in FIG. 7 are indicated in a sample period unit, the average group delay values have 669, 283, 141, 71, 35, 18, and 10 sample periods, respectively. In this case, the sample rate is 48,000 per second. The 669 sample period is an averaged value of the group delays of FIG. 7 in a frequency range from 88.4 Hz to 176.8 Hz, that is, the band-pass frequency of the band-pass filter1. An averaged value of the group delays of FIG. 7 in a frequency range from 125 Hz to 176.8 Hz, that is, the center frequency of the band-pass filter1, is a 465 sample period. The 669 sample period corresponds to 13.94 ms because the sample rate is 48,000 per second. In an embodiment of the present disclosure, in order to limit a latency in the filter unit 100 to 10 ms, the group delay value of the band-pass filter1 is adjusted from the 669 sample period to a 480 sample period.

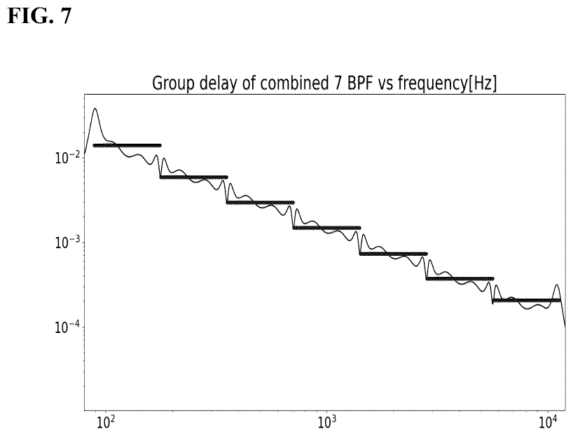

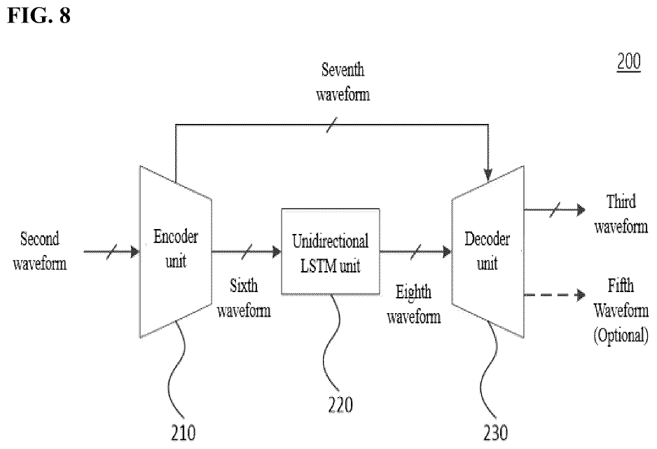

FIG. 8 is a diagram illustrating detailed components of the deep learning unit of the apparatus for removing ambient noise from a speech waveform using band-pass filters and deep learning according to the present disclosure.

As illustrated in FIG. 8, the deep learning unit 200 of the apparatus for removing ambient noise from a speech waveform using band-pass filters and deep learning according to the present disclosure has a U-net structure including an encoder unit 210, a unidirectional LSTM unit 220, and a decoder unit 230. A seventh waveform, that is, a middle output of the encoder unit 210, is used as a middle input to the decoder unit 230.

Conventionally, a deep learning unit includes one encoder and one decoder because the deep learning unit outputs only one speech waveform. In contrast, in the present disclosure, the deep learning unit 200 includes one encoder and L or (L+1) decoders because the deep learning unit outputs L or (L+1) waveforms.

The number of waveforms is also called the number of channels. A mono speech waveform has one waveform, and the number of channels thereof is 1. A stereo speech waveform has two waveforms, and the number of channels thereof is two. For example, a mono speech waveform which has one waveform and the number of channels of which is one, and the number of samples of which is 10000 is indicated as wave_1D [10000], that is, a one-dimensional vector. A waveform having the numbers of waveforms and channels that are each 5, and the number of samples of each channel, that is, 10000, is indicated as wave_2D [10000, 5], that is, a two-dimensional matrix, etc.

The deep learning unit 200 according to the present disclosure may receive L second waveforms as an input, may output L third waveforms, and may further selectively output one fifth waveform. If this is represented as the number of channels, the deep learning unit 200 receives L channel waveforms as an input, and outputs L or (L+1) channel waveforms.

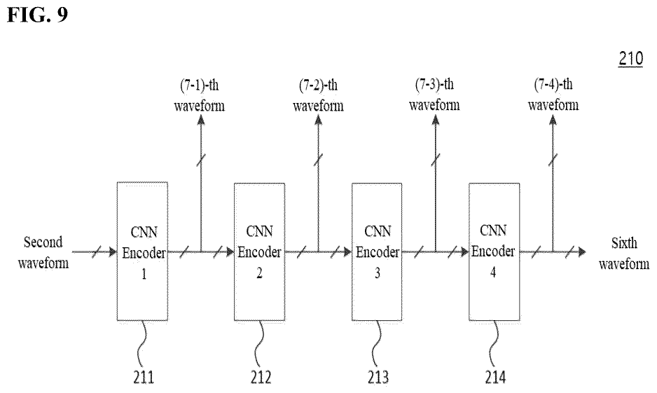

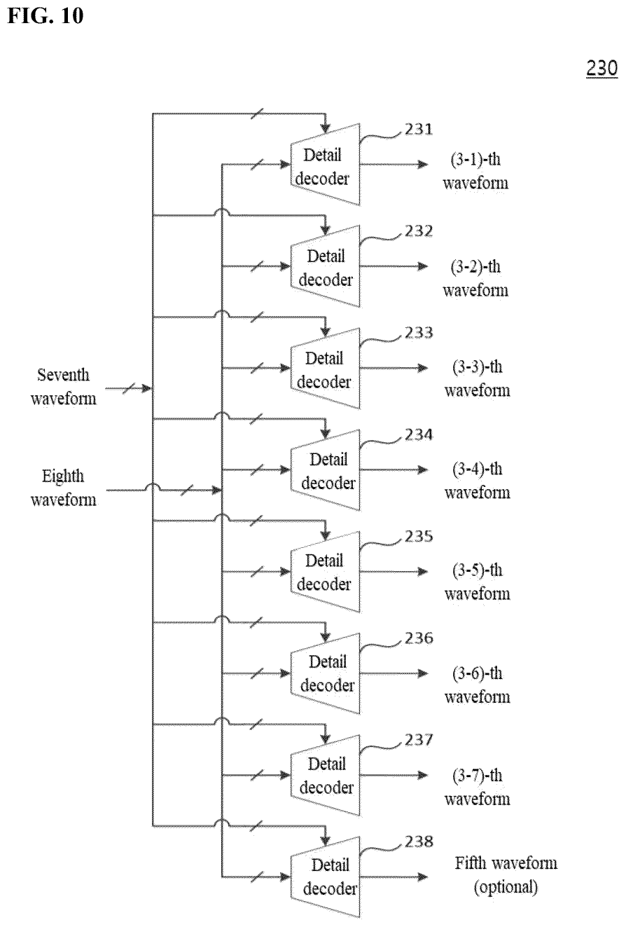

FIG. 9 is a diagram illustrating detailed components of the encoder unit of the deep learning unit illustrated in FIG. 8. FIG. 10 is a diagram illustrating detailed components of the decoder unit of the deep learning unit illustrated in FIG. 8.

The encoder unit 210 includes one large encoder, and the decoder unit 230 includes L or (L+1) small decoders. In an embodiment of the present disclosure, L=7. In the encoder unit 210, M CNN encoders have different numbers of inputs and outputs connected in series. In an embodiment of the present disclosure, M=4.

The CNN is one of deep learning methods, and indicates a convolutional neural network. As illustrated in FIG. 9, four CNN encoders (a CNN encoder1 211, a CNN encoder2 212, a CNN encoder3 213, and a CNN encoder4 214) that constitute the encoder unit 210 each have a structure in which two one-dimensional CNN layers are connected in series. An operation of each CNN encoder is regulated by four variable values, that is, the number of input waveforms (the number of input channels) and the number of output waveforms (the number of output channels), the number of kernel times (kernel_time) that determines the number of deep learning weights, and the number of stride times (stride_time) indicative of a sample interval that is used as an actual input in an input waveform.

In an embodiment of the present disclosure, the number of input channels and the number of output channels, of the CNN encoder1 211 in FIG. 9, are 7 and 30, respectively, and the number of stride times thereof is 2. Accordingly, the second waveform and a (7_1)-th waveform, that is, the input and output of the CNN encoder1, are indicated as a matrix in which the dimensions of the second waveform and the (7_1)-th waveform are [T, 7] and [T/2, 30], respectively. In this case, T indicates the number of samples of the second waveform in a time domain, which is calculated by the CNN encoder1 at a time. If the sample rate is 48,000 per second, T of a speech waveform having a length of 1 second is 48,000. The reason why the number of samples of the (7_1)-th waveform is reduced to T/2 is that the number of output samples becomes half the number of input samples because the number of stride times is 2 and the CNN encoder1 uses only every one of the two samples of the second waveform, that is, an input, which are temporally continuous, in the calculation of deep learning.

In an embodiment of the present disclosure, {the number of input channels, the number of output channels} combinations of the CNN encoder1 211, the CNN encoder2 212, the CNN encoder3 213, and the CNN encoder4 214 are {7, 30}, {30, 60}, {60, 120}, and {120, 240}, respectively, and the number of stride times of the CNN encoders are 2, 3, 4, and 4, respectively. Accordingly, a (7_1)-th waveform, a (7_2)-th waveform, a (7_3)-th waveform, and a (7_4)-th waveform are indicated as a matrix of [T/2, 30], [T/6, 60], [T/24, 120], and [T/96, 240].

In an embodiment of the present disclosure, the number of kernels that is used for the one-dimensional CNN calculation of the CNN encoder1 211, the CNN encoder2 212, the CNN encoder3 213, and the CNN encoder4 214 is 8. The seventh waveform illustrated in FIGS. 8 and 10 has a combination of the four waveforms (the (7_1)-th waveform, the (7_2)-th waveform, the (7_3)-th waveform, and the (7_4)-th waveform), and is called a skip net, which is used as a middle input to the decoder unit 230.

The unidirectional LSTM unit 220 illustrated in FIG. 8 includes a J layer, receives a sixth waveform (the (7_4)-th waveform) as an input, and outputs an eighth waveform. The reason why a uni-directional LSTM is used instead of a bi-directional LSTM is to reduce the entire latency of the apparatus for removing ambient noise according to the present disclosure. In an embodiment of the present disclosure, since J=3, the unidirectional LSTM unit 220 has a long short term memory (LSTM) structure having three layers, and the sixth waveform, that is, the input of the unidirectional LSTM unit, and the eighth waveform, that is, the output thereof, are indicated as a matrix of [T/96, 240].

As illustrated in FIG. 10, the decoder unit 230 is constructed in a form in which L or (L+1) detail decoder units are connected in parallel. In an embodiment of the present disclosure, eight detail decoders 231 to 238 are used because L=7. The eight detail decoders 231 to 238 have all the same structure, and have the same number of input waveforms and the same dimension of output waveforms. The detail decoders 231 to 238 each receive the seventh waveform and the eighth waveform as an input, and output respective waveforms (a (3_1)-th waveform, a (3_2)-th waveform, a (3_3)-th waveform, a (3_4)-th waveform, a (3_5)-th waveform, a (3_6)-th waveform, a (3_7)-th waveform, and a fifth waveform), respectively, which are indicated as a matrix of [T, 1]. The matrix of [T, 1] is the same as [T], that is, one-dimensional vector.

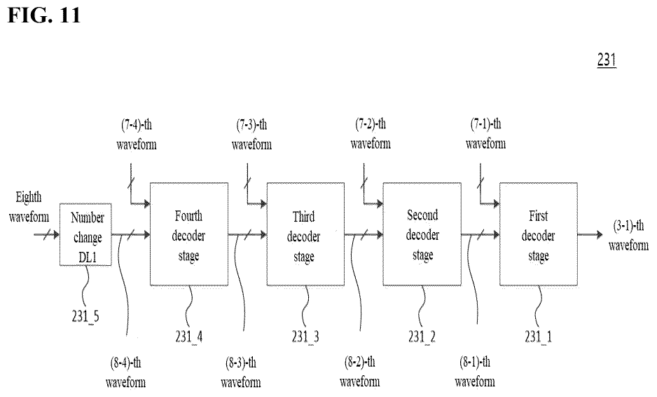

FIG. 11 is a diagram illustrating detailed components of the detail decoder of the decoder unit illustrated in FIG. 10.

FIG. 11 illustrates the detailed components of the first detail decoder 231 that outputs the (3_1)-th waveform, among the detail decoders 231 to 238. The first detail decoder 231 has a structure in which one number change deep learning device (number change DL1) 231_5 and M decoder stages are connected in series. In an embodiment of the present disclosure, M=4, and the M decoder stages include a fourth decoder stage 231_4, a third decoder stage 231_3, a second decoder stage 231_2, and a first decoder stage 231_1. The number change deep learning device 231_5 generates an (8_4)-th waveform having a dimension [T/96, 85] by receiving the eighth waveform having the dimension [T/96, 240]. The fourth decoder stage 231_4 outputs an (8_3)-th waveform having a dimension [T/24, 42] by receiving the (7_4)-th waveform having the dimension [T/96, 240] and the (8_4)-th waveform. The third decoder stage 231_3 outputs an (8_2)-th waveform having a dimension [T/6, 21] by receiving the (7_3)-th waveform having the dimension [T/24, 120] and the (8_3)-th waveform. The second decoder stage 231_2 outputs an (8_1)-th waveform having a dimension [T/2, 11] by receiving the (7_2)-th waveform having the dimension [T/6, 60] and the (8_2)-th waveform. The first decoder stage 231_1 outputs the (3_1)-th waveform having the dimension [T, 1] by receiving the (7_1)-th waveform having the dimension [T/2, 30] and the (8_1)-th waveform.

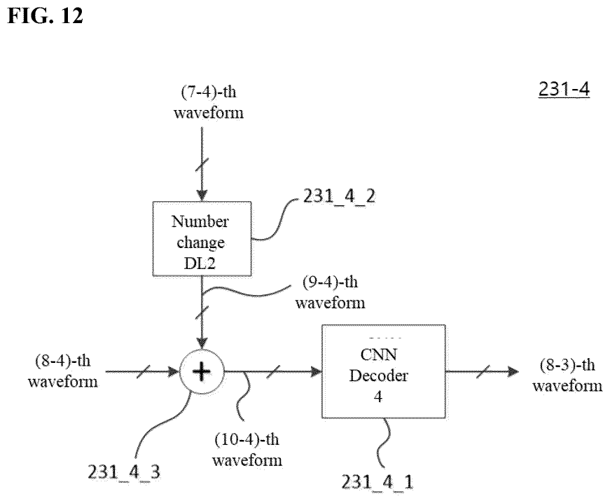

FIG. 12 is a diagram illustrating detailed components of the fourth decoder stage of the detail decoder illustrated in FIG. 11.

As illustrated in FIG. 12, the fourth decoder stage 231_4 includes one CNN decoder4 231_4_1, one number change deep learning device (number change DL2) 231_4_2, and one summing unit 231_4_3, and outputs the (8_3)-th waveform having the dimension [T/24, 42] by receiving the (8_4)-th waveform having the dimension [T/96, 85] and the (7_4)-th waveform having the dimension [T/96, 240]. The number change deep learning device 231_4_2 outputs a (9_4)-th waveform having the dimension [T/96, 85] by receiving the (7_4)-th waveform having the dimension [T/96, 240]. The summing unit 231_4_3 outputs a (10_4)-th waveform having a dimension [T/96, 85] by summing up the (9_4)-th waveform and the (8_4)-th waveform. The CNN decoder4 231_4_1 outputs the (8_3)-th waveform having the dimension [T/24, 42] by receiving the (10_4)-th waveform, and performs an inverse function of the CNN encoder4 214 illustrated in FIG. 9.

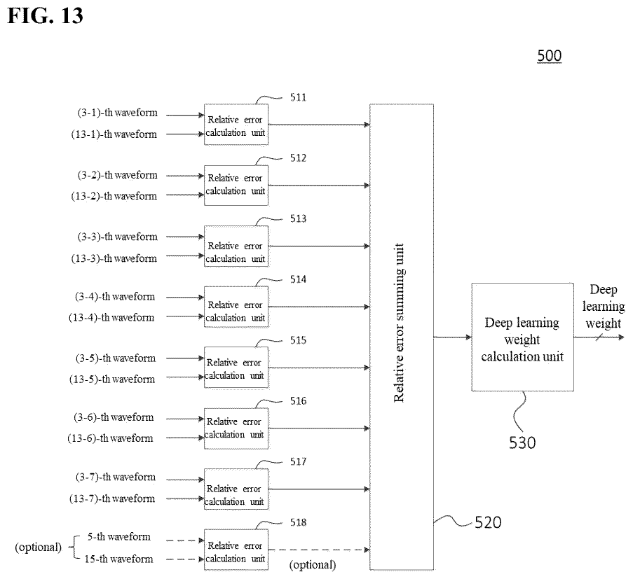

FIG. 13 is a diagram illustrating detailed components of the deep learning training engine of the apparatus for removing ambient noise from a speech waveform using band-pass filters and deep learning according to the present disclosure.

As illustrated in FIG. 13, the deep learning training engine 500 outputs deep learning weights by receiving the third waveform and the thirteenth waveform each having a dimension [T, 7] and the fifth waveform and the fifteenth waveform each having a dimension [T, 1]. The third waveform is a combination of seven waveforms (the (3_1)-th waveform, the (3_2)-th waveform to the (3_7)-th waveform) each having the dimension [T, 1]. The thirteenth waveform is also a combination of seven waveforms (a (13_1)-th waveform, a (13_2)-th waveform to a (13_7)-th waveform) each having the dimension [T, 1] like the third waveform.

The seven waveforms (the (13_1)-th waveform, the (13_2)-th waveform to the (13_7)-th waveform) are output waveforms generated by passing the clean ground truth speech waveform through the seven band-pass filters (the second filter unit 600) having different band-pass frequencies as illustrated in FIG. 2. An operation of the second filter unit 600 is exactly the same as that of the filter unit 100. The fifteenth waveform is a waveform obtained by storing the pitch information of the clean ground truth speech waveform in the sine wave form during the voiced speech time interval of the clean ground truth speech waveform.

Eight relative error calculation units 511, 512, 513, 514, 515, 516, 517, and 518 each output an average relative error value calculated according to Equation 1 by receiving the two waveforms each having the dimension [T, 1]. In the relative error calculation unit 511 that receives the (3_1)-th waveform and the (13_1)-th waveform as an input, a term [i, 1], that is, the i-th sample value of the (3_1)-th waveform, becomes noisy [i] in Equation 1. A term [i, 1], that is, the i-th sample value of the (13_1)-th waveform, becomes clean[i] in Equation 1. In the relative error calculation unit 518 that receives the fifth waveform and the fifteenth waveform, a term [i, 1], that is, the i-th sample value of the fifth waveform, becomes noisy [i] in Equation 1. A term [i, 1], that is, the i-th sample value of the fifteenth waveform, becomes clean[i] in Equation 1.

The values of the sixteen waveforms (the seven third waveforms, the seven thirteenth waveforms, the fifth waveform, and the fifteenth waveform) that are input to the deep learning training engine 500 are floating point numbers having a range from −1 to +1. The relative error summing unit 520 sums up the output values of the relative error calculation units of the seven relative error calculation units 511 to 517 or the eight relative error calculation units 511 to 518, and outputs a result value as an average relative error sum value. The deep learning calculation unit 530 receives the average relative error sum value as an input, performs an iteration process by using an optimization algorithm, and determines deep learning weight values so that the average relative error sum value is decreased every iteration process.

In an embodiment of the present disclosure, an Adam method was used as the optimization algorithm. A value obtained by dividing the average relative error sum value by the number of relative error calculation units that was used for the summing-up with respect to a data set for validation was optimized to be 11.5% or less. A clean ground truth speech waveform data set of about 159 hours was used for the deep learning training. For the verification of the deep learning, a clean ground truth speech waveform data set of about 38 hours was used. The data set for the deep learning and the data set for the validation do not overlap each other. The first speech waveform was generated by adding the clean ground truth speech waveform and ambient noise waveform of about 80 hours. The redundancy of the ambient noise waveform was minimized. A signal to noise ratio (SNR) was made different by making different the sum ratio of the clean ground truth speech waveform and the ambient noise waveform every data segment in the summing process.

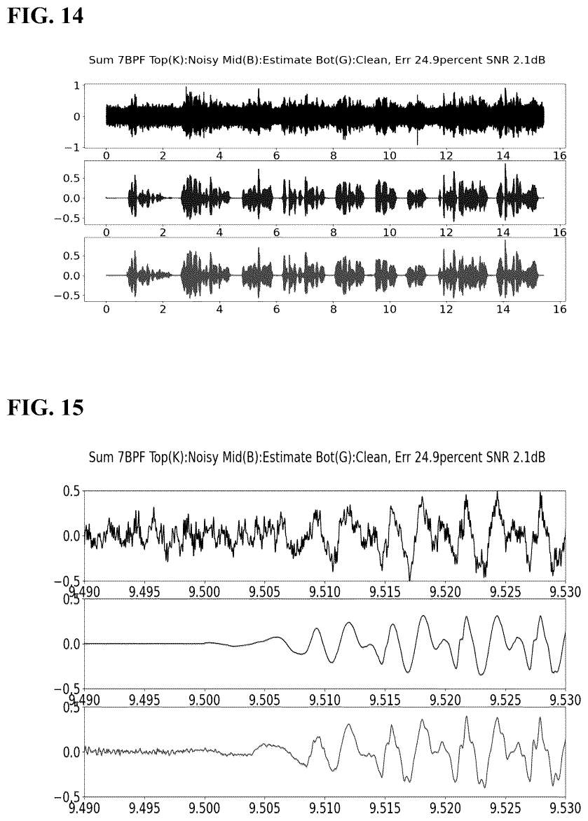

Results obtained by applying a speech waveform combined with ambient noise of about 15.4 seconds to the first speech waveform by executing the apparatus for removing ambient noise from a speech waveform using band-pass filters and deep learning according to the present disclosure are illustrated in FIGS. 14 to 23.

FIG. 14 is a diagram illustrating all of waveforms according to the execution of the deep learning unit of the apparatus for removing ambient noise from a speech waveform using band-pass filters and deep learning according to the present disclosure.

In FIG. 14, a top waveform is a waveform obtained by summing up the seven second waveforms generated by passing the first speech waveform through the filter unit 100. A middle waveform is a waveform obtained by combining the seven third waveforms, that is, the output of the deep learning unit 200, with the fourth speech waveform, that is, the output waveform of the apparatus for removing ambient noise according to the present disclosure. A bottom waveform is a waveform obtained by summing up the seven thirteenth waveforms generated by passing the clean ground truth speech waveform through the second filter unit 600 illustrated in FIG. 2. The SNR of the input waveform is relatively low 2.1 dB. An average relative error of the ground truth waveform (the thirteenth waveform) of the output waveform (the fourth speech waveform) is 24.9%.

FIG. 15 is an enlarged diagram of some intervals of all of the waveforms of FIG. 14.

FIG. 15 illustrates only 9.49 seconds to 9.53 seconds by enlarging a transverse axis in FIG. 14. It may be seen that the output waveform (the fourth speech waveform) of the apparatus for removing ambient noise according to the present disclosure, which is illustrated in the middle, is almost the same as the lower ground truth waveform. However, high frequency components illustrated in a bottom waveform are rarely seen in a middle waveform. It is determined that the reason for this is that the SNR of the input waveform that is used in this example of a high frequency component of 2000 Hz or more is excessively low (SNR <-18.9 dB).

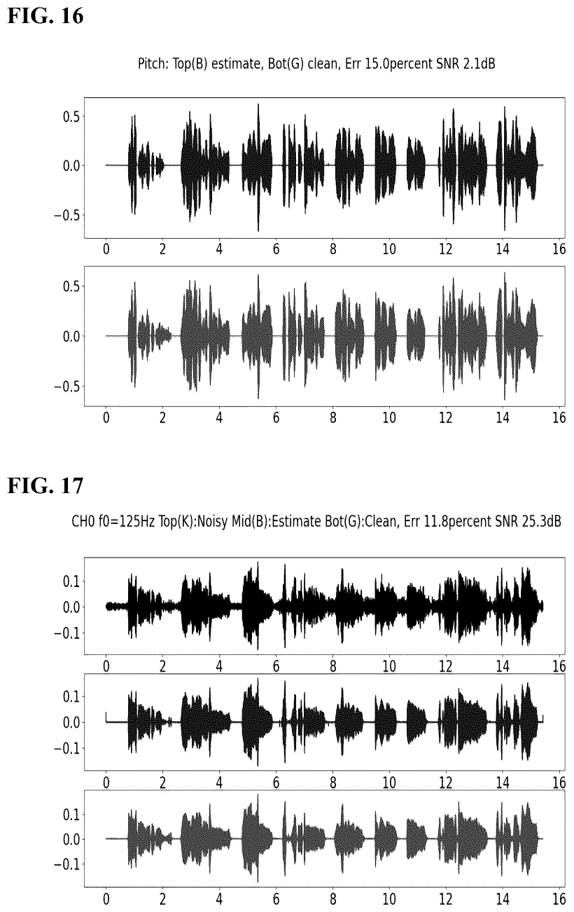

FIG. 16 is a diagram illustrating pitch waveforms according to the execution of the deep learning unit of the apparatus for removing ambient noise from a speech waveform using band-pass filters and deep learning according to the present disclosure. Referring to FIG. 16, it may be seen that an average relative error of the deep learning output waveform (the fifth waveform), that is, a top waveform, to the clean ground truth speech waveform (the fifteenth waveform), that is, a bottom waveform, is 15%.

FIGS. 17 to 23 are diagrams illustrating output waveforms of the first to seven band-pass filters according to the execution of the deep learning unit of the apparatus for removing ambient noise from a speech waveform using band-pass filters and deep learning according to the present disclosure.

In FIG. 17, waveforms corresponding to the band-pass frequency of the first band-pass filter 111 (a center frequency 125 Hz) were compared. An average relative error of an output waveform (a middle waveform, the (3_1)-th waveform) according to the present disclosure to a ground truth waveform (a bottom waveform, the (13_1)-th waveform) is excellent at 11.8%. It may be seen that the SNR of an input waveform (a top waveform, the (2_1)-th waveform) is in good condition at 25.3 dB.

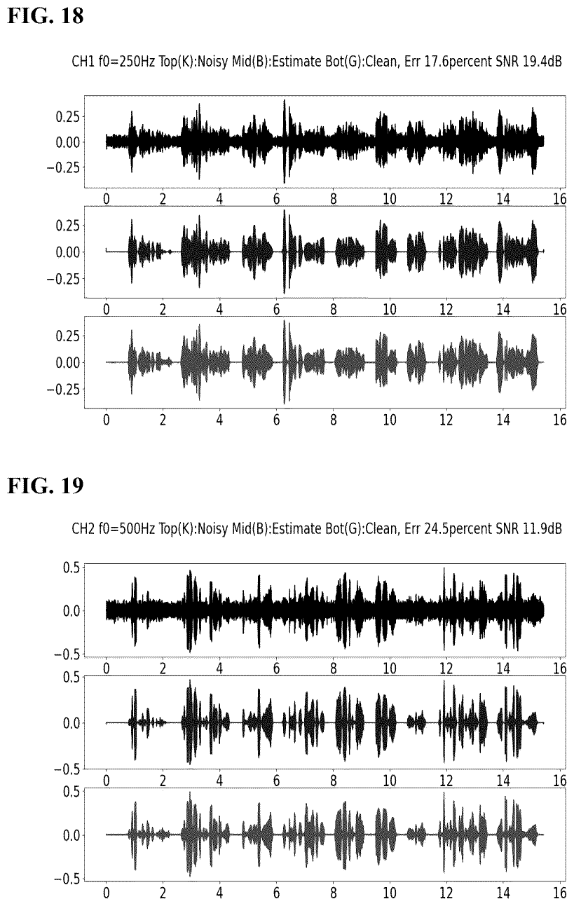

In FIG. 18, waveforms corresponding to the band-pass frequency of the second band-pass filter 121 (a center frequency 250 Hz) were compared. An average relative error of an output waveform (a middle waveform, the (3_2)-th waveform) according to the present disclosure to a ground truth waveform (a bottom waveform, the (13_2)-th waveform) is excellent 17.6%. It may be seen that the SNR of an input waveform (a top waveform, the (2_2)-th waveform) is excellent 19.4 dB.

In FIG. 19, waveforms corresponding to the band-pass frequency of the third band-pass filter 131 (a center frequency 500 Hz) were compared. An average relative error of an output waveform (a middle waveform, the (3_3)-th waveform) according to the present disclosure to a ground truth waveform (a bottom waveform, the (13_3)-th waveform) is 24.5%. The two waveforms are almost the same other than a slight difference around 2 seconds. It may be seen that the SNR of an input waveform (a top waveform, the (2_3)-th waveform) is in good condition at 11.9 dB.

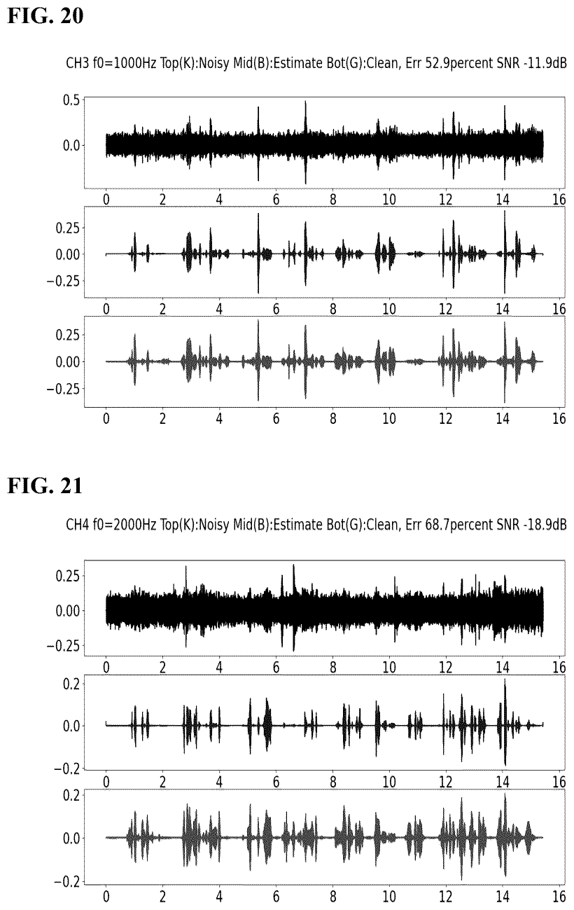

In FIG. 20, waveforms corresponding to the band-pass frequency of the fourth band-pass filter 141 (a center frequency 1000 Hz) were compared. An average relative error of an output waveform (a middle waveform, the (3_4)-th waveform) according to the present disclosure to a ground truth waveform (a bottom waveform, the (13_4)-th waveform) is 52.9%. The two waveforms are generally the same other than a slight difference around 2 seconds and in some parts at which amplitude is suddenly changed with respect to time. It may be seen that the SNR of an input waveform (a top waveform, the (2_4)-th waveform) is-11.9 dB, indicating that the quality is relatively poor.

In FIG. 21, waveforms corresponding to the band-pass frequency of the fifth band-pass filter 151 (a center frequency 2000 Hz) were compared. An average relative error of an output waveform (a middle waveform, the (3_5)-th waveform) according to the present disclosure to a ground truth waveform (a bottom waveform, the (13_5)-th waveform) is 68.7%. There is slightly a difference in several parts. It may be seen that the SNR of an input waveform (a top waveform, the (2_5)-th waveform) is −18.9 dB, indicating that the quality is quite poor.

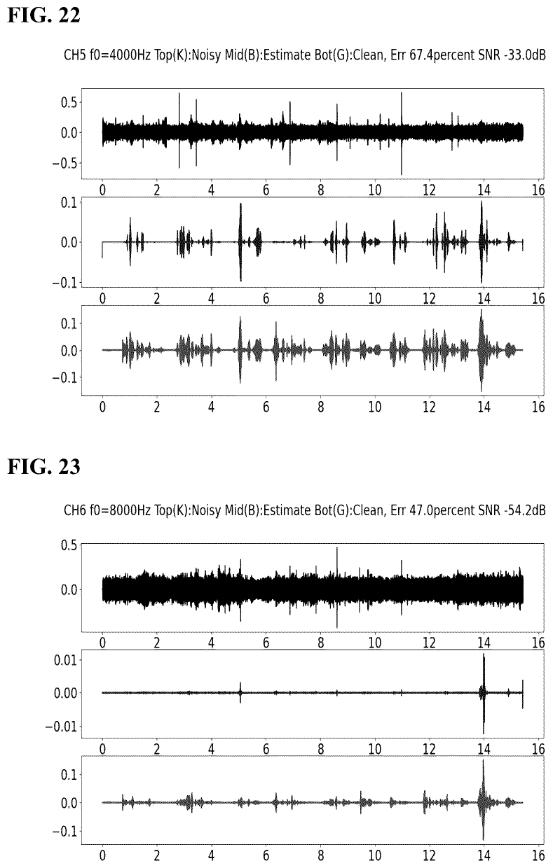

In FIG. 22, waveforms corresponding to the band-pass frequency of the sixth band-pass filter 161 (a center frequency 4000 Hz) were compared. An average relative error of an output waveform (a middle waveform, the (3_6)-th waveform) according to the present disclosure to a ground truth waveform (a bottom waveform, the (13_6)-th waveform) is 67.4%, which is quite poor. The two waveforms also have a great difference in several parts. It may be seen that the SNR of an input waveform (a top waveform, the (2_6)-th waveform) is −33.0 dB that is not very good.

In FIG. 23, waveforms corresponding to the band-pass frequency of the seventh band-pass filter 171 (a center frequency 8000 Hz) were compared. An average relative error of an output waveform (a middle waveform, the (3_7)-th waveform) according to the present disclosure to a ground truth waveform (a bottom waveform, the (13_7)-th waveform) is 47.0%. In this case, amplitude of the output waveform is excessively smaller than that of the ground truth waveform. It may be seen that the SNR of an input waveform (a top waveform, the (2_7)-th waveform) is −54.2 dB, indicating that the quality is excessively poor.

Based on the results, it may be seen that the ambient noise apparatus according to the present disclosure well operate when the SNR of an input waveform for each band-pass frequency of each band-pass filter is more than −12 dB, and does not well operate when the SNR is −12 dB or less.

As described above, the present disclosure relates to a method of reducing ambient noise in a person's speech waveform, and uses the following two methods in order to effectively remove ambient noise.

In the first method, the L second waveforms generated by passing the first speech waveform through the L band-pass filters having different band-pass frequencies are used as an input for deep learning without directly applying the deep learning to the first speech waveform, that is, an input speech waveform. The L deep learning output waveforms (the third waveform) are generated. The deep learning is trained so that average relative error values of the L third waveforms to the L thirteenth waveforms generated by passing the clean ground truth speech waveform obtained by removing ambient noise from the speech waveform through the L band-pass filters. Accordingly, noise can be uniformly removed for each frequency band of the first speech waveform. The reason for this is that if deep learning is directly applied to an input speech waveform, low frequency noise having high intensity is well removed, but high frequency noise that has low intensity, but is well heard by a person's ear is not well removed because a person's ear can well hear a sound having low intensity with respect to a high frequency speech of about 3000 Hz to 4000 Hz, but can well hear only a sound having high intensity with respect to a low frequency speech of several hundreds of Hz.

In the second method, based on the fact that the pitch waveform of a speech is robust against noise due to its great amplitude, one output waveform is added to L output waveforms of the deep learning unit 200. The deep learning unit is trained so that the added output waveform outputs pitch waveform information of a clean ground truth speech waveform. Accordingly, ambient noise can be effectively removed by allowing the deep learning unit to use the pitch waveform information of the clean ground truth speech waveform when calculating the L third waveforms.

1. An apparatus for removing ambient noise from a speech waveform, the apparatus comprising:
an ambient noise removal unit configured to receive a first speech waveform as an input, remove noise through filtering and deep learning, and then output a fourth speech waveform; and
a deep learning training unit configured to calculate deep learning weights that are used in deep learning through the deep learning training and to provide the deep learning weights to the ambient noise removal unit.

2. The apparatus of claim 1, wherein the ambient noise removal unit comprises:
a filter unit configured to output a plurality of second waveforms by receiving the one first speech waveform as an input;
a deep learning unit configured to output a plurality of third waveforms by receiving the plurality of second waveforms as an input; and
a summing unit configured to output the one fourth speech waveform by summing up the plurality of third waveforms.

3. The apparatus of claim 2, wherein:
the filter unit comprises a plurality of delayed filters configured to output the plurality of second waveforms by receiving the one first speech waveform as an input,
one delayed filter has a structure in which one band-pass filter and one delay unit are connected in series, and
each of the delay units included in the plurality of delayed filters compensates for a difference between pieces of latency of the band-pass filters included in the plurality of delayed filters by delaying a signal by different latency having a predetermined value so that all of pieces of latency of the plurality of delayed filters are identical with each other.

4. The apparatus of claim 2, wherein the deep learning unit comprises:
an encoder unit configured to output a plurality of seventh waveforms and a plurality of sixth waveforms by receiving the plurality of second waveforms as an input;
a unidirectional LSTM unit configured to output a plurality of eighth waveforms by receiving the plurality of sixth waveforms as an input; and
a decoder unit configured to outputs the plurality of third waveforms by receiving the plurality of seventh waveforms and the plurality of eighth waveforms as an input,
wherein the encoder unit has a structure in which a plurality of CNN encoders is connected in series, and
the decoder unit has a structure in which a plurality of detail decoders each outputting one waveform that constitutes the third waveform by receiving the seventh waveform and the eighth waveform as an input is connected in parallel.

5. The apparatus of claim 4, wherein the decoder unit further comprises one detail decoder configured to output one fifth waveform by receiving the seventh waveform and the eighth waveform as an input.

6. The apparatus of claim 4, wherein each of the plurality of detail decoders comprises:
a first number change deep learning device configured to receive the eighth waveform as an input; and
a plurality of decoder stages connected to the first number change deep learning device in series and configured to receive the seventh waveform as an additional input.

7. The apparatus of claim 6, wherein the deep learning training unit comprises:
a second summing unit configured to receive a clean ground truth speech waveform and an ambient noise waveform as an input and to generate the first speech waveform by summing up the clean ground truth speech waveform and the ambient noise waveform;
a second filter unit configured to output a plurality of thirteenth waveforms by receiving the clean ground truth speech waveform as an input; and
a deep learning training engine configured to calculate the deep learning weights by receiving the plurality of thirteenth waveforms and the plurality of third waveforms generated by the ambient noise removal unit as an input and to provide the deep learning weights to the ambient noise removal unit.

8. The apparatus of claim 7, wherein the deep learning training unit further comprises a pitch sine wave generator configured to output a plurality of fifteenth waveforms by receiving the clean ground truth speech waveform as an input and to provide the plurality of fifteenth waveforms to the deep learning training engine.

9. The apparatus of claim 7, wherein the deep learning training engine comprises:
a plurality of relative error calculation units configured to calculate average relative error values of the plurality of third waveforms for the plurality of thirteenth waveforms;
a relative error summing unit configured to calculate an average relative error sum value by summing up the average relative error values output by the plurality of relative error calculation units; and
a deep learning weight calculation unit configured to calculate the deep learning weights so that the average relative error sum value is reduced.

10. The apparatus of claim 9, wherein the deep learning training engine further comprises one relative error calculation unit configured to calculate average relative error values of the plurality of fifth waveforms for the plurality of fifteenth waveforms.

11. A method of removing ambient noise from a speech waveform by using the apparatus according to claim 8, the method comprising:
generating a plurality of deep learning output waveforms by using a plurality of narrow band waveforms, which is generated by passing an input speech waveform through a plurality of band-pass filters, as an input for deep learning, and then generating an output speech waveform having ambient noise greatly reduced by summing up the plurality of output waveforms,
wherein the deep learning additionally outputs one waveform in addition to the deep learning output waveforms,
the deep learning is trained so that the added waveform outputs pitch information of a clean speech waveform from which ambient noise has been removed in a speech waveform combined with the ambient noise, and
pitch information of one speech waveform learnt by the deep learning is used to generate the plurality of deep learning output waveforms.

12. The method of claim 11, wherein the pitch sine wave generator
generates a twenty-first speech waveform obtained by delaying the clean ground truth speech waveform by latency of first speech waveform of the second waveform,
extracts all of pitch start times of the twenty-first speech waveform during a voiced speech time interval of the twenty-first speech waveform, and
generates one fifteenth waveform having a sine wave, having a period identical with a pitch period of the twenty-first speech waveform, and having a maximum value at the pitch start time of the twenty-first speech waveform.

13. The method of claim 12, wherein:
the deep learning training engine adds an average relative error value of the fifth waveform for the fifteenth waveform to the average relative error sum value in a deep learning training process and then determines a deep learning weight value so that the added average relative error sum value is reduced, and
the deep learning unit uses the pitch information of the clean ground truth speech waveform when learning the pitch information of the clean ground truth speech waveform and outputting the plurality of third waveforms.

14. A method of removing ambient noise from a speech waveform by using the apparatus according to claim 9, the method comprising:
generating a plurality of deep learning output waveforms by using a plurality of narrow band waveforms, which is generated by passing an input speech waveform through a plurality of band-pass filters, as an input for deep learning, and then generating an output speech waveform having ambient noise greatly reduced by summing up the plurality of output waveforms,
wherein the deep learning additionally outputs one waveform in addition to the deep learning output waveforms,
the deep learning is trained so that the added waveform outputs pitch information of a clean speech waveform from which ambient noise has been removed in a speech waveform combined with the ambient noise, and
pitch information of one speech waveform learnt by the deep learning is used to generate the plurality of deep learning output waveforms.

15. The method of claim 14, wherein the pitch sine wave generator
generates a twenty-first speech waveform obtained by delaying the clean ground truth speech waveform by latency of first speech waveform of the second waveform,
extracts all of pitch start times of the twenty-first speech waveform during a voiced speech time interval of the twenty-first speech waveform, and
generates one fifteenth waveform having a sine wave, having a period identical with a pitch period of the twenty-first speech waveform, and having a maximum value at the pitch start time of the twenty-first speech waveform.

16. The method of claim 15, wherein:
the deep learning training engine adds an average relative error value of the fifth waveform for the fifteenth waveform to the average relative error sum value in a deep learning training process and then determines a deep learning weight value so that the added average relative error sum value is reduced, and
the deep learning unit uses the pitch information of the clean ground truth speech waveform when learning the pitch information of the clean ground truth speech waveform and outputting the plurality of third waveforms.
